(19) United States
(12) Patent Application Publication
(10) Pub. No.: US 2026/0365438 A1
(43) Pub. Date: Nov. 19, 2026

(54) TOOL FOR HANDLING PLATES

(71) Applicant: Petróleo Brasileiro S.A. – Petrobras, Rio de Janeiro (BR)

(72) Inventors: Romario De Carvalho NUNES, Macaé (BR); Joao Paulo URBANO, Macaé (BR)

(21) Appl. No.: 19/676,345

(22) Filed: May 13, 2026

(30) Foreign Application Priority Data
May 19, 2025 (BR) 1020250100541

(51) Int. Cl. B65G 7/12

(52) U.S. Cl. CPC B65G 7/12

(57) ABSTRACT

The present disclosure is applied in the area of subsea equipment technologies and, more particularly, relates to a tool for handling plates (10), comprising: a handle (20); an impact absorption element (30); a first clamp (40) that connects the handle (20) to the impact absorption element (30); a curved rod (50); and a second clamp (60) that connects the impact absorption element (30) to the curved rod (50); wherein the curved rod (50) has a recess (521) to fit a plate.

### CROSS-REFERENCE

This application claims priority to Brazilian Patent Application No. 1020250100401, filed May 19, 2025, which is incorporated herein in its entirety by reference thereto.

### FIELD

The present disclosure is applied in the area of underwater tool and equipment technologies and, more particularly, relates to a tool for handling flat or curved plates by means of a remotely operated vehicle (ROV).

### BACKGROUND

During specific underwater interventions, it is necessary to use an ROV to handle and move plates, such as in covers, to open, close, or simply move them to different positions.

Currently, when it is required to move a plate, or open/close a door in an underwater environment, it becomes necessary to build a specific tool for the situation on demand, either locally, as on the ship, or requiring a long-term solution, in which case it is manufactured on land. This requires more time to operate, decreasing the productivity of the operation and, depending on the case, increasing the operational and even safety risk due to the longer time required to obtain the solution.

Furthermore, designing a tool suitable for use by an ROV includes taking ergonomics into account so that an ROV gripper can hold, rotate, and move the tool with dexterity and accuracy, even in restricted access environments. At the same time, the tool to be developed for this purpose needs to have a certain malleability to absorb the impacts from the own loading of the ROV and from waves or sea currents.

Therefore, the state of the art lacks the development of a tool that is versatile enough to move plates and open/close covers and doors in a subsea environment.

In view of the problems mentioned above, a tool for handling plates (Plate Pulling Handle, also called PLA) has been developed as a solution by the present disclosure, capable of accessing the location of the plate to be handled, even in situations of restricted or difficult access.

The tool of the present disclosure is slender and can be built to the desired length to have the necessary reach. Furthermore, the tool can be used in circumstances where the sheet does not have a place to be handled. In this case, a small diameter hole is made in it so that a part of the tool enters the hole to move the sheet.

Thus, the present disclosure solves and minimizes the difficulties described above by standardizing a type of tool format, with possibilities of different dimensions and assemblies (modular structure), which facilitates application in various scenarios.

### STATE OF THE ART

The State of the Art shows some documents that disclose subject matters within the technological field of the present disclosure.

The document US 2004/0245789 A1 discloses a lid handling tool that includes a handle, an elongated portion extending from the handle, and an engagement portion extending from the elongated portion. The engagement portion includes a notch for engaging, removing, and relocating the lid. The tool may also include other features, such as one or more openings for attaching a test tool, a rotating handle, an adjustable elongated portion, and a support member. In use, the engagement portion will be passed through an opening in the cover. The notch inside the engagement portion will engage an edge that is adjacent to the opening. Then, by lifting directly upwards, the cover can be released from the drain.

However, the document US 2004/0245789 A1 is silent on disclosing, or suggesting, an impact absorption element to mitigate the forces applied by an ROV, as proposed by the present disclosure. Furthermore, the impact absorption element of the present disclosure also acts to reduce the stresses caused by ocean currents, since the tool of the present disclosure is designed for offshore applications, unlike the device in the document US 2004/0245789 A1, which is manufactured for applications in swimming pools, i.e., conditions of little or no vibration caused by wave movements. In addition, the aforementioned document also does not disclose or suggest the use of clamps to connect the different portions of the tool, as is the case with the present disclosure, which allows greater freedom to interchange the different parts of the tool. Finally, the document US 2004/0245789 A1 also does not disclose or suggest that the tip of the metal rod should preferably be tapered to facilitate insertion of the tool into the hole in a plate, and that the metal rod itself should be curved to facilitate handling by an ROV.

The document U.S. Pat. No. 6,868,570 B2 discloses a hand tool that can be used as a wrench and a hook. One end of the tool has a handle and the other end, a hook. The hook has a lever tip used to open service safe lids. A wrench socket is arranged in the handle. The hook can be used as a handle to turn the wrench socket on the opposite end of the tool. Maintenance crews can use the built-in wrench to remove bolts from safe lids without kneeling. The tool can then be inverted and used as a hook to lift the safe lid without bending down to hold the edge of the safe lid. This can reduce back injuries to maintenance crews. Furthermore, injuries from snake and spider bites are reduced because maintenance teams do not need to use their hands to open the safe lids.

However, it is noted that the device in the document U.S. Pat. No. 6,868,570 B2 has a single structure, not segmented into modules, which makes the interchangeability of two parts difficult. In addition, the document does not mention or suggest an impact absorption element and clamps to connect the different portions of the tool. Since the tool in U.S. Pat. No. 6,868,570 B2 was designed for land-based applications, it would not be consistent to think that an impact absorption element could be inserted to mitigate the forces from both the ROV and those caused by ocean currents.

### BRIEF DESCRIPTION

The present disclosure relates to a tool for handling plates, applicable to scenarios that would require the movement of plates by ROV in a subsea environment, whether in the sense of pulling or pushing a plate, opening or closing covers, and related operations, with flat or curved geometry.

The tool of the present disclosure operates through a recess near its end/tip that fits into the plates to be operated on. Upon fitting, the ROV, through the handle of the tool, designed for it, moves the same and, consequently, the plates.

Furthermore, the tool of the present disclosure is adaptable to the operating scenario, since different parts of it can be interchanged by opening one or two of its two clamps, one of which is fixed to the handle and the other fixed to a metal rod. The function of the clamps is precisely to make the connection between parts of the tool of the present disclosure, which are the handle to the impact absorption element on one side and the impact absorption element to the rod on the other.

Thus, the objectives and advantages of the present disclosure are achieved by providing, in one embodiment, a tool for handling plates comprising: a handle; an impact absorption element; a first clamp that connects the handle to the impact absorption element; a curved rod; and a second clamp that connects the impact absorption element to the curved rod; wherein the curved rod has a recess to fit a plate.

### BRIEF DESCRIPTION OF THE FIGURES

The preferred embodiments of this disclosure will be better understood when read in conjunction with the accompanying drawings. It should be understood, however, that the disclosure in question is not limited only to the precise arrangements and instruments shown.

Thus, the present disclosure will now be described with reference to its typical embodiments and with reference to the accompanying drawings.

FIG. 1A shows a perspective view of the tool for handling plates containing its main components, according to an embodiment of the present disclosure.

FIG. 1B shows a schematic view of the tool for handling plates being handled by a remotely operated vehicle (ROV), according to an embodiment of the present disclosure.

FIG. 2 shows a cross-sectional view of a first clamp of the tool for handling plates, according to an embodiment of the present disclosure.

FIG. 3 shows a cross-sectional view of a second clamp of the tool for handling plates, according to an embodiment of the present disclosure.

FIG. 4 shows a side view of the second clamp fixedly connected to an inclined portion of a curved rod of the tool for handling plates, according to an embodiment of the present disclosure.

### DETAILED DESCRIPTION

Reference is made in detail to preferred embodiments of the present disclosure, illustrated in the accompanying drawings. Wherever possible, the same or similar reference numbers will be used throughout the drawings to refer to identical or similar features. It should be noted that the drawings are in simplified form and are not represented to precise scale, so minor variations are expected.

It is worth highlighting that the expressions “plate(s)”, “sheet(s)”, “door(s)”, as used in the text of the present disclosure, are equivalent in meaning and not limiting in relation to the application of the tool of the present disclosure, since they generally refer to structures with a parallelepiped shape, or even polygonal elements of various shapes (triangle, quadrilateral, pentagon, etc.) having a certain thickness/height.

The present disclosure relates to a tool for handling plates via ROV that aims to move a plate located in a submerged environment, such as opening or closing a cover or moving a plate.

The present disclosure addresses and reduces the difficulties mentioned above, having been designed primarily for ROVs, but also being suitable for use by a human diver, if necessary.

Furthermore, the present disclosure applies in situations where it is desired to operate an ROV for handling flat or curved plates, including in more restricted and difficult-to-access locations.

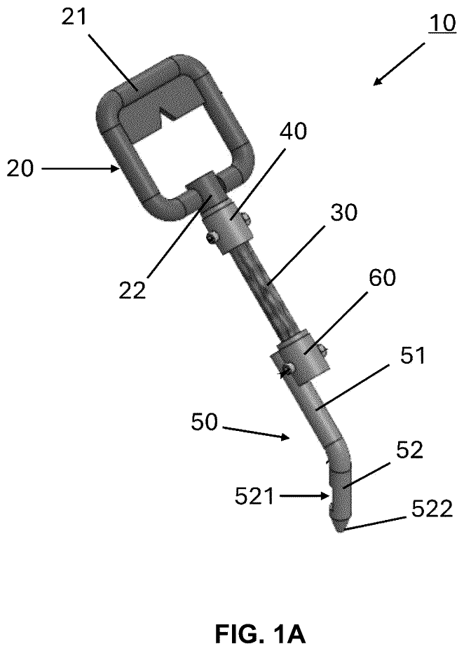

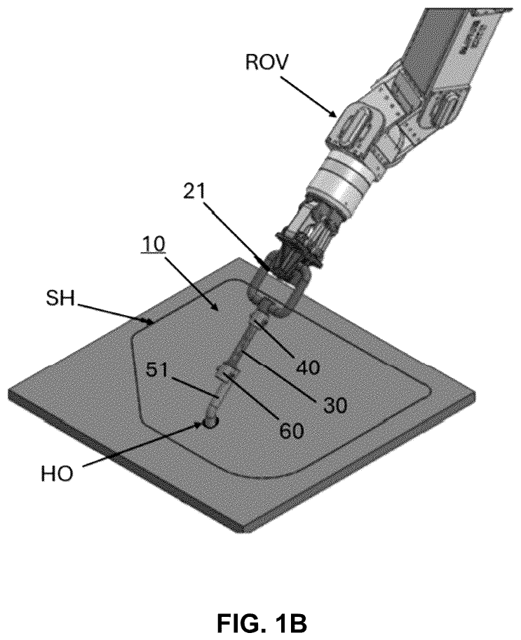

Thus, reference is made to FIGS. 1A and 1B, which show, respectively, a tool for handling plates (10) containing its main components, according to an embodiment of the present disclosure, and said tool (10) being inserted into a hole (HO) of a plate (SH) to be handled. The tool (10) comprises: a handle (20); an impact absorption element (30); a first clamp (40) that connects the handle (20) to the impact absorption element (30); a curved rod (50); and a second clamp (60) that connects the impact absorption element (30) to the curved rod (50); wherein the curved rod (50) has a recess (521) to fit into a plate.

The handle (20) has a gripping portion (21) so that an ROV can hold and handle the handle (20). FIGS. 1A and 1B show a handle (20) in a square shape. It should also be noted that the handle (20) of the present disclosure can be adapted to different types of ROV grippers (with two fingers, three fingers, parallel, among others), so that the handle (20) can have any of the following shapes: “T”, triangular, fish tail, among others.

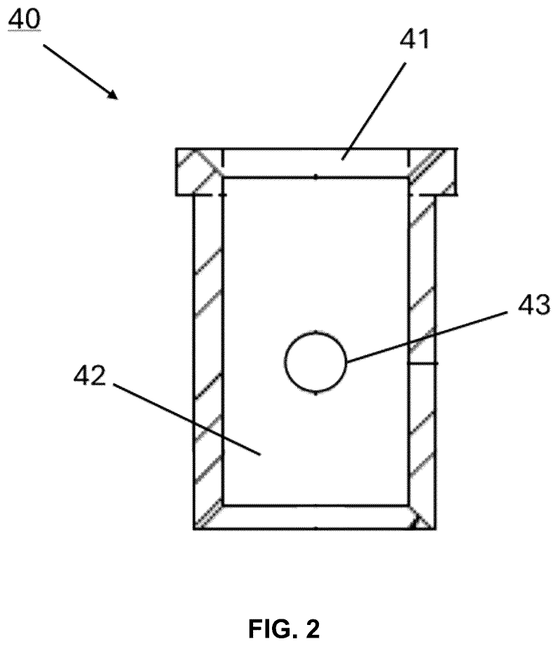

Furthermore, the first clamp (40), of tubular shape and preferably metallic, is fixedly connected (by welding, for example) to the handle (20). More specifically, a top portion (41) of the first clamp (40) is fixedly connected to a tubular lower portion (22) of the handle (20), as shown in FIGS. 1A and 2. The first clamp (40) also has an internal channel (42) along the longitudinal direction of the first clamp (40) to receive the impact absorption element (30). Furthermore, the first clamp (40) has two holes (43) arranged on opposite sides of each other and aligned with each other so that a screw can pass between them.

The impact absorption element (30) is used to mitigate impacts from the excessive force of the ROV itself and also from sea currents, which may act during the handling and movement of the tool (10). In one embodiment of the present disclosure, the impact absorption element (30) has two through holes, each through hole being arranged in close proximity to a corresponding end of the impact absorption element (30). Thus, an upper end of the impact absorption element (30) is fitted into the first clamp (40), more specifically into the internal channel (42) of the first clamp (40), so that the through hole near the upper end of the impact absorption element (30) is aligned with the holes (43) of the first clamp (40). In this way, a screw passes through the aligned holes of the first clamp (40) and the impact absorption element (30) to connect the impact absorption element (30) to the handle (20) by means of the first clamp (40). Furthermore, nuts are used to securely fasten the screw, as can be seen in FIG. 1A. It should be noted that the impact absorption element (30) is removably connected to the handle (20), i.e., by removing the fastening elements (nuts and screw) the impact absorption element (30) can be removed and replaced. This feature is extremely advantageous, as it facilitates component maintenance and allows modification not only of the material of the impact absorption element (30) but also of its dimensions (shorter or longer), should the tool (10) need to operate in a hard-to-reach environment, for example.

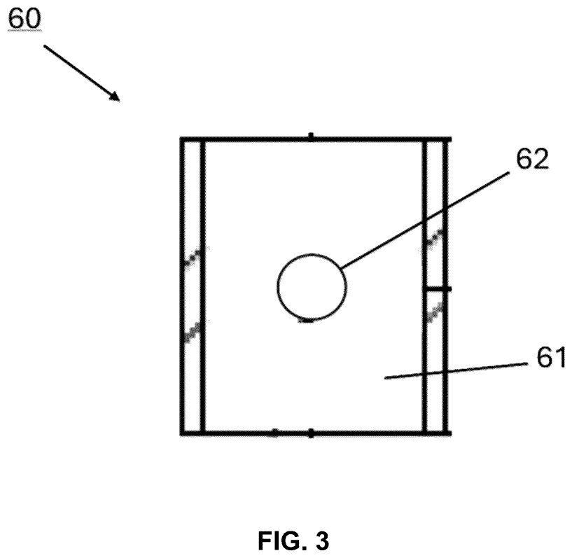

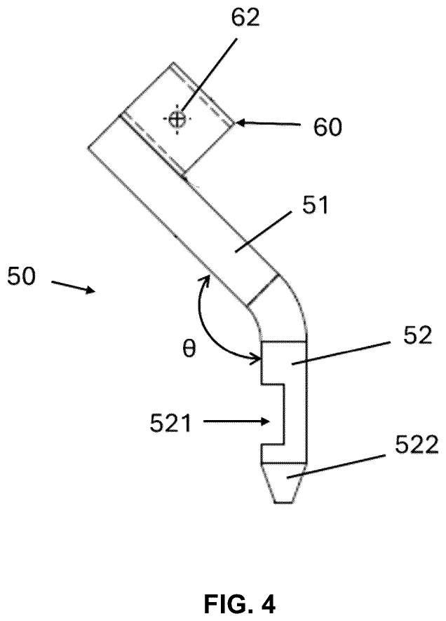

FIG. 3 shows the second clamp (60) of the tool (10). The second clamp (60), like the first clamp (40), also has a tubular shape and is preferably metallic. In addition, the second clamp (60) is fixedly connected (by welding, for example) onto an inclined portion (51) of the curved rod (50), as best seen in FIG. 4. Furthermore, the second clamp (60) has an internal channel (61) along the longitudinal direction of the second clamp (60).

According to one embodiment of the present disclosure, the second clamp (60) further includes two holes (62) arranged on opposite sides of each other and aligned with each other so that a screw passes between them.

Thus, a lower end of the impact absorption element (30) is fitted into the second clamp (60), more specifically into the inner channel (61) of the second clamp (60), so that the through hole near the lower end of the impact absorption element (30) is aligned with the holes (62) of the second clamp (60). In this way, a screw passes through the aligned holes of the second clamp (60) and the impact absorption element (30) to connect the impact absorption element (30) to the inclined portion (51) of the curved rod (50) by means of the second clamp (60). Furthermore, nuts are used to securely fasten the screw, as can be seen in FIG. 1A. It should be noted that the impact absorption element (30) is connected in a removable manner to the inclined portion (51) of the curved rod (50), that is, when removing the fastening elements (nuts and bolt) the impact absorption element (30) can be removed and replaced, as is established for the connection between the impact absorption element (30) and the handle (20) by means of the first clamp (40).

The curved rod (50), as previously mentioned, has an inclined portion (51) and a vertical portion (52), as shown in FIG. 4. The inclined portion (51) extends in a direction substantially parallel to the impact absorption element (30) and forms an angle θ with the vertical portion (52). The angle θ varies between 180° and 90°, preferably around 135°. This curvature, or bending, of the curved rod (50) serves to improve the fit of the tool (10) on the plate to be handled depending on the positioning of the ROV. For some actuations of the tool (10), an angle of 45° with the horizontal plane (i.e., 135° with the vertical portion of the rod) was determined considering the expected average value of the actuations. However, this angle can be modified according to the desired actuation.

Furthermore, the vertical portion (52) of the curved rod (50) extends downwards and has a recess (521) to fit into a plate, as previously mentioned. Thus, the ROV handles the tool (10) in order to fit the recess (521) of the vertical portion (52) into a portion of a plate to be handled, as seen in an exemplary manner in FIG. 1B. Thus, the recess (521) acts as a support, or fitting portion, to hold the plate and move it.

In one embodiment of the present disclosure, the vertical portion (52) also has a conical tip (522). The conical tip (522) allows the vertical portion (52) of the curved rod (50) to be more easily inserted into a hole in a plate to be handled, for example.

Thus, the tool for handling plates (10) of the present disclosure is quite versatile, since it can be made available in different dimensions for diverse scenarios, with interchangeability of its parts, facilitating maintenance and expanding the range of applications in a subsea environment. In addition, the tool (10) developed by the present disclosure is capable of absorbing impacts due to its impact absorption element (30). The tool (10) is of slender dimensions and can be short or long, enabling access to restricted locations, also considering its conical tip end, improving performance via ROV and speeding up the operation.

Those skilled in the art will appreciate the knowledge being shown and may reproduce the disclosure in the embodiments indicated and in other variants, covered within the scope of the appended claims.

1. A tool for handling plates, comprising:
a handle;
an impact absorption element;
a first clamp connecting the handle to the impact absorption element;
a curved rod; and
a second clamp connecting the impact absorption element to the curved rod;
wherein the curved rod has a recess to fit a plate.

2. The tool for handling plates of claim 1, wherein the first clamp and the second clamp have a tubular shape and are metallic.

3. The tool for handling plates of claim 1, wherein the first clamp is fixedly connected to the handle.

4. The tool for handling plates of claim 1, wherein the first clamp has an internal channel.

5. The tool for handling plates of claim 1, wherein the first clamp also has two holes arranged on opposite sides and aligned with each other.

6. The tool for handling plates of claim 1, wherein the impact absorption element has two through holes, each through hole being arranged in proximity to a corresponding end of the impact absorption element.

7. The tool for handling plates of claim 1, wherein an upper end of the impact absorption element is fitted into an internal channel of the first clamp, so that a through hole in the vicinity of the upper end of the impact absorption element is aligned with the holes of the first clamp.

8. The tool for handling plates of claim 1, wherein the impact absorption element is removably connected to the handle through the first clamp by means of a screw and nuts.

9. The tool for handling plates of claim 1, wherein the second clamp is fixedly connected on the curved rod.

10. The tool for handling plates of claim 1, wherein the second clamp has an internal channel.

11. The tool for handling plates of claim 1, wherein the second clamp further includes two holes arranged on opposite sides of each other and aligned with each other.

12. The tool for handling plates of claim 1, wherein a lower end of the impact absorption element is fitted into an internal channel of the second clamp, so that a through hole near the lower end of the impact absorption element is aligned with the holes of the second clamp.

13. The tool for handling plates of claim 1, wherein the impact absorption element is removably connected to the curved rod via the second clamp by means of a screw and nuts.

14. The tool for handling plates of claim 1, wherein the curved rod has:
an inclined portion on which the second clamp is connected; and
a vertical portion which has the recess.

15. The tool for handling plates of claim 14, wherein the inclined portion forms an angle q with the vertical portion, wherein the angle q varies between 180° and 90°.

16. The tool for handling plates of claim 14, wherein the vertical portion has a conical tip.
